(19) United States
(12) Patent Application Publication
(10) Pub. No.: US 2016/0245648 A1
(43) Pub. Date: Aug. 25, 2016

(54) COMPUTER PRODUCT, UNEVENNESS ANALYSIS METHOD, AND UNEVENNESS ANALYZER

(71) Applicant: FUJITSU LIMITED, Kawasaki-shi (JP)

(72) Inventors: Hiroyuki TANI, Katsushika (JP); SHIN TOTOKI, Oita (JP); Tetsuya ASO, Fukuoka (JP)

(73) Assignee: FUJITSU LIMITED, Kawasaki-shi (JP)

(21) Appl. No.: 15/148,025

(22) Filed: May 6, 2016

Related U.S. Application Data
(63) Continuation of application No. PCT/JP2014/079894, filed on Nov. 11, 2014.

(30) Foreign Application Priority Data
Nov. 13, 2013 (JP) 2013-235489

(51) Int. Cl. G01B 21/30

(52) U.S. Cl. CPC G01B 21/30

(57) ABSTRACT

An unevenness analyzer obtains travel data of a vehicle. The unevenness analyzer identifies travel data for a predetermined period from a stopped state of the vehicle based on a travel status of the vehicle indicated by the obtained travel data of the vehicle. The unevenness analyzer, even when the travel data of the vehicle indicates movement at a same speed, performs with respect to travel data that belongs to the obtained travel data, comparison with travel data that does not belong to the identified travel data, and execution of road surface unevenness detection by a lowered sensitivity.

### CROSS REFERENCE TO RELATED APPLICATIONS

This is a continuation application of International Application PCT/JP2014/079894 filed on Nov. 11, 2014 which claims priority from a Japanese Patent Application No. 2013-235489 filed on Nov. 13, 2013, the contents of which are incorporated herein by reference.

### FIELD

The embodiments discussed herein are related to a computer product, an unevenness analysis method, an unevenness analyzer.

### BACKGROUND

Road surfaces are degraded by the load of vehicles such as automobiles and motorcycles, the forces of nature and aging whereby, unevenness may occur. For example, obstacles such cracks or depressions in road surfaces or cracks resulting from an earthquake cause unevenness in a road surface. Unevenness in a road surface affects the safety of vehicles traveling on the road surface and therefore, is desirably detected and remediated at an early stage.

According to a related technique, for example, an accelerometer is equipped on a vehicle, vibration of the vehicle during travel is measured as acceleration, and road surface unevenness is analyzed from the measured acceleration. For example, according to another technique, a first acceleration in an upward and downward direction at a spring and a second acceleration in an upward and downward direction at a spring are detected and corrected, and based on the corrected first and second acceleration, an index representing the flatness of a road surface is obtained. For an example of a related technique, refer to Japanese Laid-Open Patent Publication No. 2005-315675.

Nonetheless, with the conventional techniques, a problem arises in that detection of road surface unevenness is difficult. For example, even when the state of the road surface unevenness is the same, if the traveling state of the vehicle differs, the measured value obtained by an accelerometer equipped on the vehicle differs. More specifically, for example, when a vehicle is accelerating or decelerating, vertical movement is larger than when the vehicle is traveling at a constant speed and the measured acceleration value of the vehicle tends to be larger. Therefore, if the same measuring threshold is used to detect road surface unevenness without taking into consideration the traveling state of the vehicle, the accuracy of the unevenness detection may decrease.

### SUMMARY

According to an aspect of an embodiment, a non-transitory, computer-readable recording medium stores therein an unevenness analysis program that causes a computer to perform based on an analysis parameter, analysis of motion data of a mobile object and analysis of unevenness of a road surface traveled by the mobile object. The unevenness analysis program causes the computer to execute a process including identifying based on a motion status of the mobile object indicated by the motion data, first motion data that is one of motion data for a predetermined period from a stopped state of the mobile object and motion data for a predetermined distance from the stopped state of the mobile object; and performing even when the motion data of the mobile object indicates movement at a same speed, and with respect to second motion data that belongs to the identified first data, comparison with third motion data that does not belong to the identified first motion data, and executing detection of unevenness of the road surface by a reduced sensitivity.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram depicting an example of an unevenness analysis method according to a first embodiment, for road surfaces;

FIG. 2 is a diagram depicting an example of system configuration of a system 200;

FIG. 3 is a block diagram of an example of hardware configuration of an unevenness analyzer 201;

FIG. 4 is a block diagram of an example of hardware configuration of a travel data measuring device 202;

FIG. 5 is a diagram depicting one example of travel data 500;

FIG. 6 is a diagram depicting one example of the contents of analysis parameters 600;

FIG. 7 is a block diagram of an example of functional configuration of the unevenness analyzer 201;

FIG. 8 is a flowchart of an example of a procedure of a road surface unevenness analysis process by the unevenness analyzer 201;

FIG. 9 is a flowchart of an example of a procedure of a vertical acceleration correction process by the unevenness analyzer 201;

FIG. 10 is a flowchart of an example of a procedure of a brake section identifying process by the unevenness analyzer 201;

FIG. 11 is a flowchart of an example of a procedure of an accelerator section identifying process by the unevenness analyzer 201;

FIG. 12 is a diagram depicting an example of travel data 1200 in the brake section identifying process by the unevenness analyzer 201; and

FIG. 13 is a diagram depicting an example of travel data 1300 in the accelerator section identifying process by the unevenness analyzer 201.

### DESCRIPTION OF EMBODIMENTS

Embodiments of an unevenness analysis program, an unevenness analysis method, an unevenness analyzer, and a recording medium according to the present invention will be described in detail with reference to the accompanying drawings.

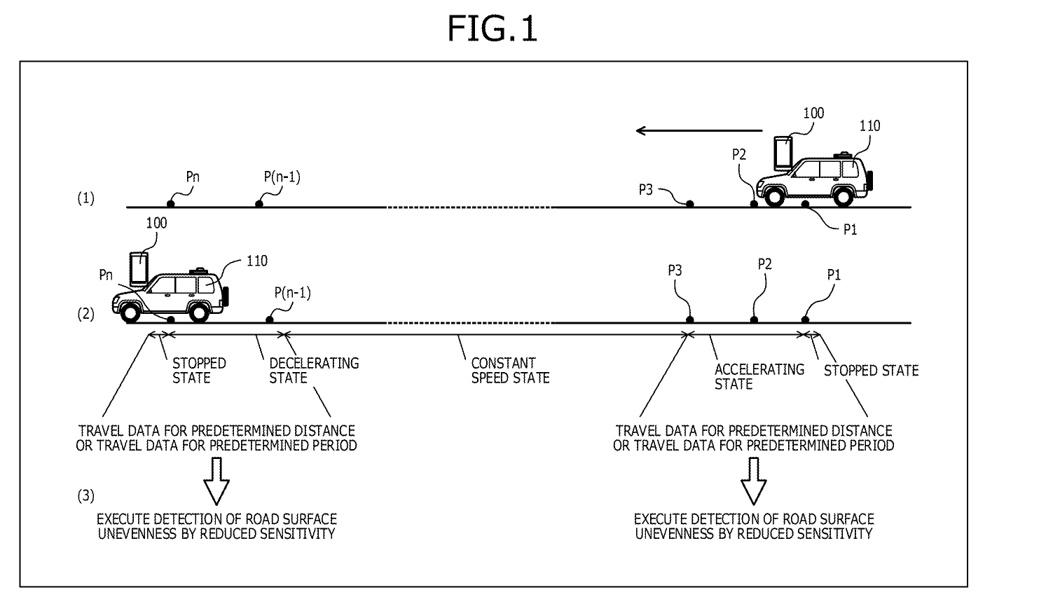

FIG. 1 is a diagram depicting an example of the unevenness analysis method according to a first embodiment, for road surfaces. In FIG. 1, an unevenness analyzer 100 is a computer that based on an analysis parameter, analyzes motion data of a mobile object 110 and analyzes the unevenness of a road surface traveled by the mobile object 110.

Here, the mobile object 110 is an object capable of powered motion on a road surface by, for example, an internal combustion engine and human power. More specifically, for example, the mobile object 110 is a vehicle such as an automobile, a motorcycle, and a bicycle that uses wheels to move on a road surface, or a snowmobile that uses rails to move on the surface of snow. Further, a road surface is the surface of a road. A road surface further includes snow surfaces and ice surfaces.

Road surface unevenness is an unlevel portion on a road surface. For example, in an uneven road surface, depressions and cracks occurring from degradation of the road surface consequent to the passage of time and vehicular load are present. Further, an uneven road surface has cracks caused by natural forces such as earthquakes, debris such as rocks put on the road by natural forces or human actions, and artificially created objects. Artificially created unevenness, for example, includes crosswalks painted on road surfaces and the like.

Motion data of the mobile object 110 is data that indicates the motion status of the mobile object 110. The motion status of the mobile object 110 represents changes in the moving state of the mobile object 110. The moving state, for example, may be a stopped state, an accelerating state, a decelerating state, a constant speed state, and the like. The stopped state is when the mobile object 110 is stopped, i.e., the speed of the mobile object 110 is 0. The accelerating state is when the velocity of the mobile object 110 increasing. The decelerating state is when the velocity of the mobile object 110 is decreasing. The constant speed state is when the speed of the mobile object 110 is substantially constant.

The motion data of the mobile object 110 includes, for example, information such as measurement position, measurement time, a measured acceleration value obtained periodically or on an irregular basis by an accelerometer equipped on the mobile object 110. Further, acceleration of the mobile object 110, for example, may be acceleration in a longitudinal direction of the mobile object 110, acceleration in a lateral direction of the mobile object 110, and acceleration in a vertical direction of the mobile object 110. Further, the accelerometer may be a vibration sensor or some other similar sensor that senses movement.

Acceleration in the respective directions, for example, is measured by sensors configured to measure acceleration in the respective directions. Further, for example, the unevenness analyzer 100 may measure the longitudinal, lateral, and vertical acceleration of the mobile object 110 by performing vector analysis of the measured values obtained by sensors configured to measure acceleration in oblique directions of the mobile object 110.

An analysis parameter is a parameter for analyzing road surface unevenness from motion data of the mobile object 110. The analysis parameter includes a measuring threshold of the accelerometer. The measuring threshold of the accelerometer is a threshold used by the unevenness analyzer 100 to detect road surface unevenness. The unevenness analyzer 100, for example, compares vertical acceleration of the mobile object 110 and the measuring threshold of the accelerometer, and when the absolute value of vertical acceleration is greater than the measuring threshold of the accelerometer, determines that the road surface is uneven.

In the description hereinafter, description will be given taking a vehicle such as an automobile, a motorcycle, a bicycle, and the like as one example of the mobile object 110. Further, in the description hereinafter, the mobile object 110 will be indicated as “vehicle 110”, and the motion data of the mobile object 110 will be indicated as “travel data of the vehicle 110”.

Here, when the vehicle 110 is traveling in an urban area, there are sections where the speed of the vehicle 110 has to be reduced or the vehicle 110 has to be stopped consequent to other vehicles 110 or traffic signals. Therefore, during travel, the travel status of the vehicle 110 transitions through various states such as the stopped state, the accelerating state, the decelerating state, and the constant speed state.

On the other hand, even when the state of the road surface unevenness is the same, if the travel status of the vehicle 110 differs, the measured value obtained by the accelerometer equipped on the vehicle 110 may differ. Therefore, if road surface unevenness is detected using the same measuring threshold without taking the travel status of the vehicle 110 into consideration, the accuracy of unevenness detection may decrease.

For instance, when the vehicle 110 is accelerating or decelerating, vertical movement becomes larger than when the vehicle 110 is traveling at a constant speed and therefore, the measured value of vertical acceleration of the vehicle 110 tends to be larger. More specifically, for example, when the vehicle 110 is traveling 30 km/h on a road and is accelerating having transitioned from the stopped state to the accelerating state, the vertical acceleration tends to be greater than the acceleration when the vehicle 110 is traveling at a constant speed of 30 km/h on the same road. Therefore, for example, if the vehicle 110 is assumed to be traveling at a constant speed of 30 km/h and the measuring threshold of the accelerometer is defined, road surface unevenness may be errantly detected when the vehicle 110 is accelerating from the stopped state and traveling at 30 km/h on a flat road.

Thus, in the first embodiment, the unevenness analyzer 100 executes unevenness detection by reducing the sensitivity of road surface unevenness detection when the traveling vehicle 110 is accelerating from a stopped state or decelerating state to a stopped state to be lower than that for other states. As a result, the unevenness analyzer 100 can analyze road surface unevenness with high accuracy by taking into consideration the effects of increasing acceleration with respect to the travel status of the vehicle 110. Hereinafter, an example of an unevenness analysis process of the unevenness analyzer 100 will be described.

(1) The unevenness analyzer 100 obtains travel data of the vehicle 110. The travel data of the vehicle 110, for example, is information that includes the acceleration of the vehicle 110 measured at a constant period or at a constant distance by the accelerometer equipped on the vehicle 110. In the example depicted in FIG. 1, the unevenness analyzer 100 obtains travel data that includes the acceleration of the vehicle 110 measured at measuring points P1 to Pn. The accelerometer may be provided in the unevenness analyzer 100 or may be provided on the vehicle 110.

(2) Based on the travel status of the vehicle 110 indicated by the obtained travel data, the unevenness analyzer 100 identifies travel data for a predetermined distance or travel data for a predetermined period from a stopped state of the vehicle 110.

Here, travel data for a predetermined period (or within a predetermined distance) from a stopped state of the vehicle 110, for example, is travel data measured during a period (or, a distance) of a section where the vehicle 110 is accelerating and the travel status of the vehicle 110 transitions from a stopped state to an accelerating state, and transitions from the accelerating state to a constant speed state. Alternatively, the travel data is travel data measured during a period (or distance) of a section where the vehicle 110 is decelerating and the travel status of the vehicle 110 transitions from the decelerating state to a stopped state.

Further, travel data for a predetermined period (or, a predetermined distance) from a stopped state of the vehicle 110 may be travel data measured during a predetermined period (or predetermined distance) from the stopped state when the travel status of the vehicle 110 transitions from a stopped state to an accelerating state. Alternatively, the travel data may be travel data measured during a predetermined period (or predetermined distance) until a stopped state when the travel status of the vehicle 110 transitions from a decelerating state to the stopped state. The predetermined period (or predetermined distance) in this case can be set arbitrarily and, for example, a value of several seconds (or, several meters) is set.

In the example depicted in FIG. 1, the travel status of the vehicle 110 changes between a stopped state, an accelerating state, a constant speed state, a decelerating state, and a stopped state. More specifically, for example, the travel status is a stopped state at point P1, an accelerating state from point P1 to point P3, a constant speed state from point P3 to point P(n−1), a decelerating state from point P(n−1) to point Pn, and a stopped state at point Pn. In this case, the unevenness analyzer 100 identifies travel data that includes acceleration from point P1 to point P3, and from point P(n−1) to point Pn.

(3) The unevenness analyzer 100 makes comparison concerning the identified travel data and travel data not belonging to the identified travel data, and executes detection of road surface unevenness by a reduced sensitivity, even when the travel data of the vehicle 110 indicates movement at the same speed. Here, detection of road surface unevenness is a process of comparing vertical acceleration of the vehicle 110 and the measuring threshold of the accelerometer, and determining that unevenness is present in a road surface when the absolute value of the vertical acceleration is greater than the measuring threshold of the accelerometer.

Further, a lowering of the sensitivity of road surface unevenness detection is making a condition for the unevenness analyzer 100 to determine that unevenness of a road surface stricter. For example, concerning travel data belonging to the identified travel data, the unevenness analyzer 100 may increase the measuring threshold of the accelerometer and compare the increased measuring threshold and the vertical acceleration to thereby, execute detection of road surface unevenness.

Further, the unevenness analyzer 100 may set travel data belonging to the identified travel data to be excluded from road surface unevenness detection. The unevenness analyzer 100 may make the absolute value of the vertical acceleration of the identified travel data smaller and compare the absolute value of the vertical acceleration for which the absolute value has been made smaller and the measuring threshold of the accelerometer to thereby, execute detection of road surface unevenness.

As described, according to the unevenness analyzer 100 of the first embodiment, unevenness detection can be executed by a sensitivity that has been set to be lower than for other travel data and that is based on travel data for a predetermined distance or travel data for a predetermined period from a stopped state of the vehicle 110.

For example, according to the unevenness analyzer 100, when the vehicle 110 is in an accelerating state from a stopped state, or a decelerating state to a stopped state, unevenness detection can be executed with the sensitivity of road surface unevenness detection being set lower than for other states. As a result, the unevenness analyzer 100 can analyze road surface unevenness with a high accuracy by taking into consideration the effects of the travel status of the vehicle 110 on the detection of road surface unevenness.

An example of system configuration of a system 200 according to a second embodiment will be described. Portions identical to those described in the first embodiment are given the same reference numerals used in the first embodiment and description thereof is omitted hereinafter.

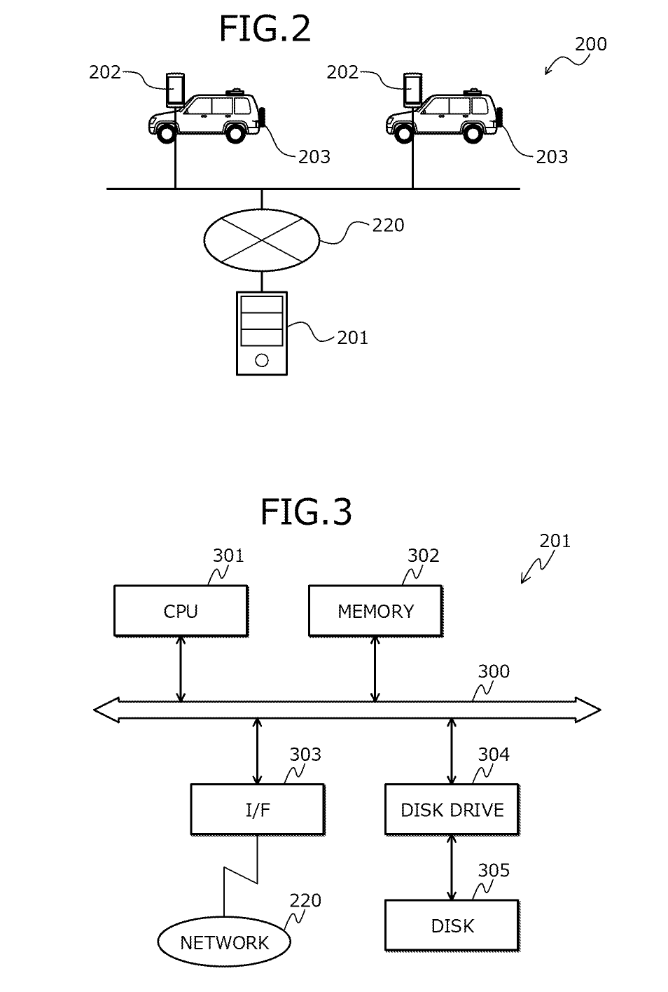

FIG. 2 is a diagram depicting an example of system configuration of the system 200. In FIG. 2, the system 200 includes an unevenness analyzer 201, a travel data measuring device 202 (2 devices in the example depicted in FIG. 2), and a vehicle 203 (2 vehicles in the example depicted in FIG. 2). In the system 200, the unevenness analyzer 201 and the travel data measuring devices 202 are connected through a wired or a wireless network 220. The network 220, for example, is a local area network (LAN), a wide area network (WAN), the Internet, and the like.

The unevenness analyzer 201 is a computer that analyzes unevenness of a road surface traveled by the vehicles 203. More specifically, for example, the unevenness analyzer 201 is a server, a personal computer (PC), and the like.

The travel data measuring device 202 is a computer that measures travel data of the vehicle 203. More specifically, for example, the travel data measuring device 202 may be a communications device such as a smartphone, a mobile telephone, a tablet PC, and the like, and further may be a vehicle-equipped device such as a car navigation device equipped on the vehicle 203.

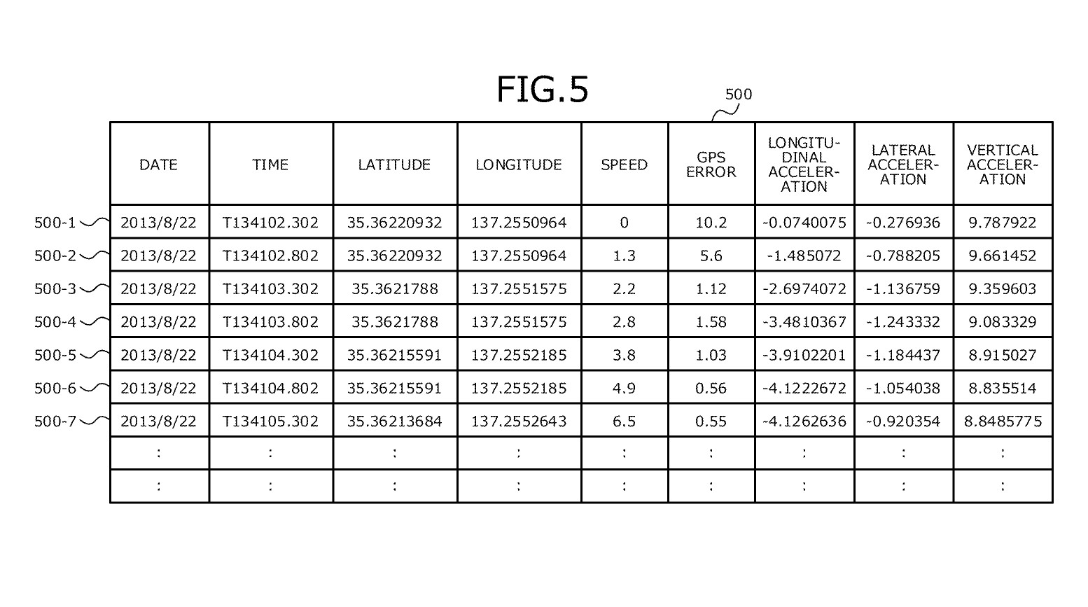

The vehicle 203 is an automobile, a motorcycle, a bicycle, and the like. Travel data of the vehicle 203 will be described in detail with reference to FIG. 5. The unevenness analyzer 201 and the travel data measuring devices 202 correspond to the unevenness analyzer 100 depicted in FIG. 1 and the vehicles 203 correspond to the mobile object 110 (the vehicle 110) depicted in FIG. 1.

FIG. 3 is a block diagram of an example of hardware configuration of the unevenness analyzer 201. In FIG. 3, the unevenness analyzer 201 has a central processing unit (CPU) 301, memory 302, an interface (I/F) 03, a disk drive 304, and a disk 305, respectively connected by a bus 300.

Here, the CPU 301 governs overall control of the unevenness analyzer 201. The memory 302, for example, includes read-only memory (ROM), random access memory (RAM), and flash ROM. More specifically, for example, the flash ROM and the ROM store various types of programs, and the RAM is used as a work area of the CPU 301. Programs stored in the memory 302 are loaded onto the CPU 301, whereby the CPU 301 executes encoded processes.

The I/F 303 is connected to the network 220 through a communications line and is connected to other computers (for example, the travel data measuring device 202 depicted in FIG. 2) via the network 220. The I/F 303 administers an internal interface with the network 220 and controls the input and output of data from other computers. The I/F 303, for example, may be a modem, a LAN adapter, and the like.

The disk drive 304 is a control device that under the control of the CPU 301, controls the reading and writing of data with respect to the disk 305. The disk drive 304, for example, may be a magnetic disk drive, an optical disk drive, and the like. The disk 305 is a medium that stores data written thereto under the control of the disk drive 304. For example, when the disk drive 304 is a magnetic disk drive, the disk 305 may be a magnetic disk. Further, the unevenness analyzer 201 may have a solid state drive (SSD) in place of the disk drive 304. When the disk drive 304 is a SSD, in place of the disk 305, semiconductor memory can be used. Further, the unevenness analyzer 201 may have a SSD in addition to the disk drive 304. In addition to the configuration above, the unevenness analyzer 201 may further have, for example, a keyboard, a mouse, a display, and the like.

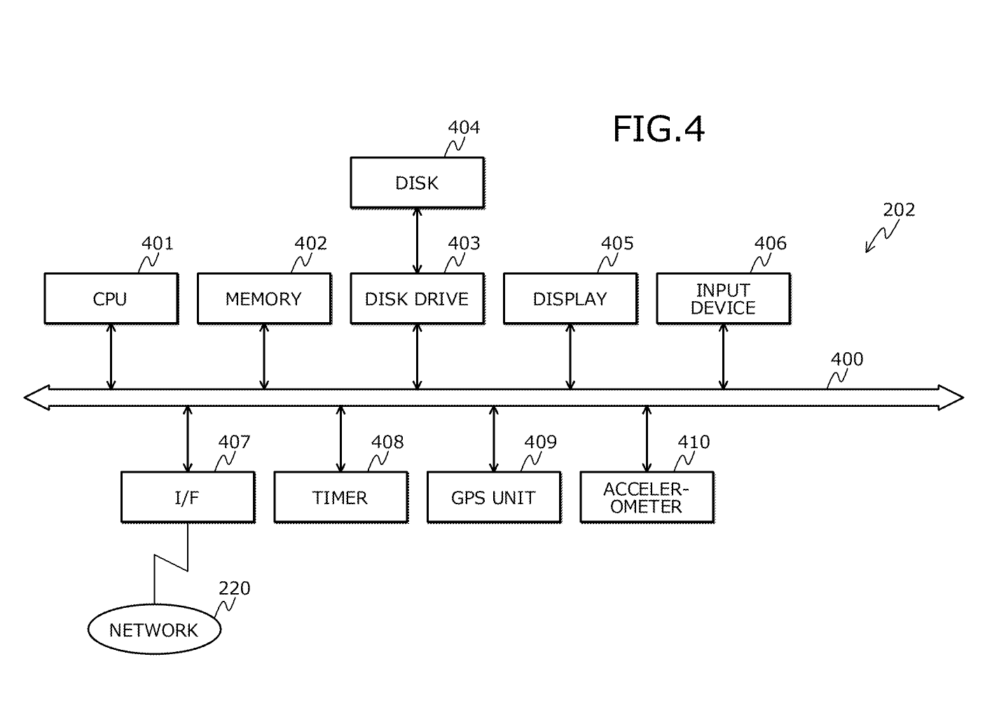

FIG. 4 is a block diagram of an example of hardware configuration of the travel data measuring device 202. In FIG. 4, the travel data measuring device 202 has a CPU 401, memory 402, a disk drive 403, a disk 404, a display 405, an input device 406, an I/F 407, a timer 408, a global positioning system (GPS) unit 409, and an accelerometer 410. The respective components are connected by a bus 400.

Here, the CPU 401 governs overall control of the travel data measuring device 202. The memory 402, for example, includes ROM, RAM, and flash ROM. More specifically, for example, the flash ROM and ROM store various types of programs; and the RAM is used as a work area of the CPU 401. Programs stored in the memory 402 are loaded onto the CPU 401 whereby, the CPU 401 executes encoded processes.

The disk drive 403 is a control device that under the control of the CPU 401, controls the reading and writing of data with respect to the disk 404. The disk drive 403 may be, for example, a magnetic disk drive, an optical disk drive, and the like. The disk 404 is a medium that stores data written thereto under the control of the disk drive 403. For example, when the disk drive 403 is a magnetic disk drive, the disk 404 may be a magnetic disk. Further, the travel data measuring device 202 may have a SSD in place of the disk drive 403. When the disk drive 403 is a SSD, in place of the disk 404, semiconductor memory can be used. Further, the travel data measuring device 202 may have a SSD in addition to the disk drive 403.

The display 405 displays data such as documents, images, and functional information in addition to a cursor, icons, and toolboxes. The display 405, for example, may be a CRT, a TFT liquid display, a plasma display, and the like. The input device 406 has keys for imputing text, numerals, instructions, and the like; and performs data input. The input device 406 may be a touch panel input pad, a numeric pad, and the like.

The I/F 407 is connected to the network 220 through a communications line and is connected to other devices (for example, the unevenness analyzer 201 depicted in FIG. 2) via the network 220. The I/F 407 administers an internal interface with the network 220, and controls the input and output of data from external devices.

The GPS unit 409 receives radio waves (GPS signals) from GPS satellites, and outputs position information indicating the position of the travel data measuring device 202 (the vehicle 203). The position information of the travel data measuring device 202 (the vehicle 203), for example, is information specifying one point on earth by latitude, longitude, altitude, etc.

The accelerometer 410 outputs tri-axial (longitudinal, lateral, and vertical) acceleration of the travel data measuring device 202. The above configuration of the travel data measuring device 202, for example, may omit the timer 408, the GPS unit 409, and the accelerometer 410. In this case, the travel data measuring device 202, for example, may obtain from a sensor equipped on the vehicle 203, the acceleration of the vehicle 203, the time, position, etc.

FIG. 5 is a diagram depicting one example of the travel data 500. In FIG. 5, the travel data 500 has fields for dates, times, latitudes, longitudes, speeds, GPS error, longitudinal acceleration, lateral acceleration, and vertical acceleration. The travel data 500 stores travel data information (for example, travel data information 500-1 to 500-7) as records consequent to information being set into the fields for respective time points during travel of the vehicle 203. In the example depicted in FIG. 5, although the travel data information is measured at 0.5-second intervals, the travel data information can be measured at constant distance intervals.

Here, the date and the time are information that indicates the date and time that the information of the record was obtained. The date and time are measured by the timer 408 of the travel data measuring device 202. The longitude and the latitude are information indicating the position of the vehicle 203 and are measured from GPS radio waves received by the GPS unit 409 of the travel data measuring device 202.

The speed is information that indicates the speed of the vehicle 203 at the time indicated in the record. The unit of the speed is km/h. Here, the travel data measuring device 202 need not directly measure the speed. For example, the travel data measuring device 202 can calculate the speed from the time, the longitude, and the latitude. The travel data measuring device 202 calculates the distance traveled by the vehicle 203, from the longitude and latitude of the travel data information 500-1 and the longitude and latitude of the travel data information 500-2. Further, the travel data measuring device 202 divides the calculated distance by the difference of the time of the travel data information 500-2 and the time of the travel data information 500-1 and thereby, calculates the speed.

The GPS error is error indicating the extent to which the latitude and longitude position information by the GPS signal may deviate. The longitudinal acceleration is information indicating longitudinal acceleration of the vehicle 203 at the time of the record. The lateral acceleration is information indicating lateral acceleration of the vehicle 203 at the time of the record. The vertical acceleration is information indicating vertical acceleration of the vehicle 203 at the time of the record. The unit of the longitudinal, lateral, and vertical acceleration, for example, is m/s².

Longitudinal acceleration takes a negative value when the mobile object accelerating since a backward force is applied to the accelerometer 410; and takes a positive value when the mobile object is decelerating. Vertical acceleration takes a positive value when the mobile object is moving upward and takes negative value when the mobile object is moving downward. Further, lateral acceleration takes a positive value when the mobile is moving rightward and takes a negative value when the mobile object is moving leftward. Depending on the installation orientation of the travel data measuring device 202, the positive and negative values of acceleration may be reversed.

The travel data 500 depicted in FIG. 5 corresponds to the travel data of the vehicle 110 depicted in FIG. 1. The travel data 500, for example, is stored to the disk 404 depicted in FIG. 4.

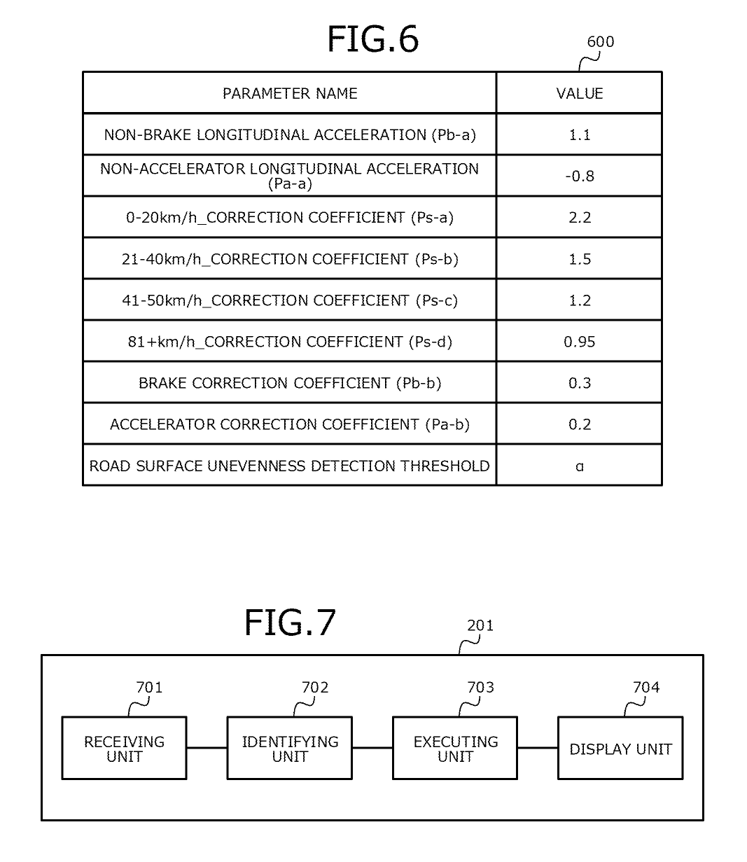

FIG. 6 is a diagram depicting one example of the contents of the analysis parameter 600. The analysis parameter 600 has values of non-brake longitudinal acceleration Pb-a, non-accelerator longitudinal acceleration Pa-a, a 0-20 km/h_correction coefficient Ps-a, a 21-40 km/h_correction coefficient Ps-b, a 41-50 km/h_correction coefficient Ps-c, a 81+km/h_correction coefficient Ps-d, a brake correction coefficient Pb-b, an accelerator correction coefficient Pa-b, and a road surface unevenness detection threshold. The analysis parameter 600, for example, is stored in the memory 302 or the disk 305 depicted in FIG. 3.

Here, the non-accelerator longitudinal acceleration Pa-a is a first threshold used for determining whether a measured section is an accelerator section. A measured section is a section that has multiple measuring points. The unevenness analyzer 201 identifies the travel status of the vehicle 203 for each measured section.

Travel status of the vehicle 203 is a traveling state of the vehicle 203 during the measured section. Traveling states, for example, include a stopped section, an accelerator section, a brake section, a constant speed section, and the like. The travel status of the vehicle 203 corresponds to the motion status of the mobile object 110 of the first embodiment. A stopped section is a section where the vehicle 203 is stopped, i.e., a section where the speed is 0. An accelerator section is a section where the vehicle 203 enters an accelerating state by the accelerator. A brake section is a section where the vehicle 203 enters a decelerating state by the brake. A constant speed section is a section where the vehicle 203 is traveling at a substantially constant speed.

The non-brake longitudinal acceleration Pb-a is a second threshold used for determining whether the measured section is a brake section.

The 0-20 km/h_correction coefficient Ps-a is a correction coefficient for vertical acceleration in a measured section where the vehicle 203 is in a constant speed state of 0-20 km/h. The 21-40 km/h_correction coefficient Ps-b, the 41-50 km/h_correction coefficient Ps-c, and the 81+km/h_correction coefficient Ps-d are similar correction coefficients. Between 51-80 km/h_correction is not performed and therefore, no corresponding correction coefficient exists.

The brake correction coefficient Pb-b is a correction coefficient for vertical acceleration in a brake section. The accelerator correction coefficient Pa-b is a correction coefficient for vertical acceleration in an accelerator section. The road surface unevenness detection threshold is a threshold for determining road surface unevenness. The unevenness analyzer 201 detects road surface unevenness by comparing the road surface unevenness detection threshold and vertical acceleration. For example, the unevenness analyzer 201 determines that unevenness is present in a road surface, when the vertical acceleration is greater than the road surface unevenness detection threshold. The road surface unevenness detection threshold corresponds to the measuring threshold of the accelerometer of the first embodiment.

FIG. 7 is a block diagram of an example of functional configuration of the unevenness analyzer 201. In FIG. 7, the unevenness analyzer 201 is configured to include a receiving unit 701, an identifying unit 702, an executing unit 703, and a display unit 704. More specifically, for example, these functions are implemented by executing on the CPU 301, a program stored in a storage apparatus such as the memory 302 and the disk 305 depicted in FIG. 3, or by the I/F 303. Process results of the functional units, for example, are stored to a storage apparatus such as the memory 302 and the disk 305 depicted in FIG. 3.

The receiving unit 701 has a function of receiving the travel data 500 from the travel data measuring device 202. The receiving unit 701 receives the travel data 500 when the unevenness analyzer 201 executes detection of road surface unevenness after the travel data measuring device 202 finishes obtaining the travel data 500 for the road surface. Further, when the unevenness analyzer 201 and the travel data measuring device 202 are connected by the network 220 which is wired, the receiving unit 701 may receive the travel data 500 from the travel data measuring device 202 in real-time. Thus, the receiving unit 701 can obtain the travel data 500 for detecting road surface unevenness.

The identifying unit 702 has a function of separating the travel data 500 received by the receiving unit 701 into measured sections, and for each measured section, identifying the travel status of the vehicle 203. The identifying unit 702 by identifying the measured section to be one of a stopped section, a brake section, an accelerator section, and a constant speed section, identifies the travel status of the vehicle 203.

The identifying unit 702 determines whether the vehicle 203 is in an accelerating state, based on a temporal change in the longitudinal acceleration included in the travel data 500 for a first measured section. The identifying unit 702, when determining the vehicle 203 to be in an accelerating state, identifies the first measured section to be an accelerator section. The identifying unit 702 determines whether the vehicle 203 is in a stopped state, based on a temporal change in the position included in the travel data 500 for a second measured section measured before the travel data 500 for the first measured section. The identifying unit 702, when determining the vehicle 203 to be in a stopped state, identifies the second measured section to be a stopped section.

The identifying unit 702 identifies whether the vehicle 203 is in a decelerating state, based on a temporal change in the longitudinal acceleration included in the travel data 500 for the first measured section. The identifying unit 702, when determining the vehicle 203 to be in a decelerating state, identifies the first measured section to be a brake section. The identifying unit 702 determines whether the vehicle 203 is in a stopped state, based on a temporal change in the position included in the travel data 500 for a second measured section measured after the travel data 500 for the first measured section. The identifying unit 702, when determining the vehicle 203 to be in a stopped state, identifies the second measured section to be a stopped section. The identifying unit 702 identifies sections other than brake sections, accelerator sections, and stopped sections to be a constant speed section.

The identifying unit 702 can determine that the vehicle 203 is in a stopped state, when there is no change in the positions included in the travel data 500 for the measured section. Further, when each longitudinal acceleration included in the travel data 500 for a measured section is the non-accelerator longitudinal acceleration Pa-a or less, the identifying unit 702 can determine that the vehicle 203 is in an accelerating state. When each longitudinal acceleration included in the travel data 500 for a measured section is the non-brake longitudinal acceleration Pb-a or greater, the identifying unit 702 can determine that the vehicle 203 is in a decelerating state.

The executing unit 703 has a function of detecting road surface unevenness by a sensitivity that corresponds to the travel status of the vehicle 203 identified by the identifying unit 702.

When the measured section has been identified to be a brake section, the executing unit 703 multiplies the vertical acceleration included in the travel data 500 and the brake correction coefficient Pb-b to reduce the absolute value of the vertical acceleration included in travel data 500. Thereafter, the executing unit 703 compares the reduced absolute value of the vertical acceleration included in the travel data 500 and the road surface unevenness detection threshold to thereby, detect road surface unevenness. The executing unit 703, for example, determines that road surface unevenness is present at a point indicated by the longitude and latitude, when the reduced absolute value of the vertical acceleration included in the travel data 500 is greater than the road surface unevenness detection threshold.

When the measured section has been identified to be a brake section, the executing unit 703 may increase the road surface unevenness detection threshold, compare the increased road surface unevenness detection threshold and the vertical acceleration included in the travel data 500, and detect road surface unevenness. The executing unit 703 determines that road surface unevenness is present at a point indicated by the longitude and latitude, when the vertical acceleration included in the travel data 500 is greater than the increased road surface unevenness detection threshold. Further, when the measured section has been identified to be a brake section, the executing unit 703 may exclude the travel data 500 from the road surface unevenness detection.

When the measured section has been identified to be an accelerator section, the executing unit 703 multiplies the vertical acceleration included in the travel data 500 and the accelerator correction coefficient Pa-b to reduce the absolute value of the vertical acceleration included in the travel data 500. Thereafter, the executing unit 703 compares the reduced absolute value of the vertical acceleration included in the travel data 500 and the road surface unevenness detection threshold to thereby, detect road surface unevenness. The executing unit 703, for example, determines that road surface unevenness is present at a point indicated by the longitude and latitude, when the reduced absolute value of the vertical acceleration included in the travel data 500 is greater than the road surface unevenness detection threshold.

Further, when the measured section has been identified to be an accelerator section, the executing unit 703 can increase the road surface unevenness detection threshold, compare the increased road surface unevenness detection threshold and the vertical acceleration included in the travel data 500, and detect road surface unevenness. The executing unit 703 determines that road surface unevenness is present at a point indicated by the longitude and latitude, when the vertical acceleration included in the travel data 500 is greater than the increased road surface unevenness detection threshold. Further, when the measured section has been identified to be an acceleration section, the executing unit 703 can exclude the travel data 500 from the road surface unevenness detection.

Here, even when the state of the road surface unevenness is the same, if the speed of the vehicle 203 differs, the value measured by the accelerometer 410 equipped on the vehicle 203 may differ. Therefore, if road surface unevenness is detected using the same measuring threshold without taking the travel status of the vehicle 203 into consideration, the accuracy of unevenness detection may decrease.

For example, since the lower the speed of the vehicle 203 is, the smaller the movement is, the measured value of vertical acceleration of the vehicle 203 tends to be smaller. More specifically, for example, the vertical acceleration of the vehicle 203 traveling at 60 km/h on a road surface having a depression tends to be greater than the vertical acceleration of the vehicle 203 when the vehicle 203 travels on the same road surface at 30 km/h.

For example, the measuring threshold of the accelerometer 410 is assumed to be defined under the assumption that the vehicle 203 travels at a constant speed of 60 km/h. In this case, when the vehicle 203 travels at a constant speed of 30 km/h on a road surface having a depression, the vertical acceleration becomes small compared to a case of travel at 60 km/h and as a result, the road surface unevenness may not be detected.

Thus, by a sensitivity that corresponds to the speed of the vehicle to execute unevenness detection with respect to a road surface traveled by the vehicle, the executing unit 703 can mitigate the effects of the travel status of the vehicle 203 on the detection of road surface unevenness and analyze road surface unevenness accurately.

When the measured section has been identified to be a constant speed section, the executing unit 703 multiplies the vertical acceleration included in the travel data 500 and a correction coefficient (Ps-a to Ps-d) that corresponds to the speed of the vehicle 203 to reduce or increase the absolute value of the vertical acceleration included in the travel data 50. Thereafter, the executing unit 703 compares the reduced or increased absolute value of the vertical acceleration included in the travel data 500 and the road surface unevenness detection threshold to thereby, detect road surface unevenness. The executing unit 703, for example, determines that road surface unevenness is present at a point indicated by the longitude and latitude, when the reduced or increased absolute value of the vertical acceleration included in the travel data 500 is greater than the road surface unevenness detection threshold.

When the speed of the vehicle 203 is 50 km/h or less, the executing unit 703 increases the absolute value of the vertical acceleration included in the travel data 500 and when the speed of the vehicle 203 is 81 km/h or greater, the executing unit 703 reduces the absolute value of the vertical acceleration included in the travel data 500.

Further, when the measured section has been identified to be a constant speed section, the executing unit 703 can correct the road surface unevenness detection threshold according to the speed of the vehicle 203, compare the corrected road surface unevenness detection threshold and the vertical acceleration included in the travel data 500, and detect road surface unevenness. The executing unit 703 determines that road surface unevenness is present at a point indicated by the longitude and latitude, when the vertical acceleration included in the travel data 500 is greater than the corrected road surface unevenness detection threshold.

When the speed of the vehicle 203 is 50 km/h or less, the executing unit 703 reduces the road surface unevenness detection threshold and when the speed of the vehicle 203 is 81 km/h or greater, the executing unit 703 increases the road surface unevenness detection threshold.

When the measured section has been identified to be a stopped section and the subsequent measured section has been identified to be an accelerator section, the executing unit 703 detects road surface unevenness for the stopped section similarly in the case of an accelerator section. Further, when the measured section has been identified to be a stopped section and the previous measured section has been identified to be a brake section, the executing unit 703 detects road surface unevenness for the stopped section similarly in the case of a brake section.

The display unit 704 has function of displaying locations of road surface unevenness detected by the executing unit 703. More specifically, for example, the display unit 704 executes display to a display, output of an alarm, print out to a printer, and transmission to an external terminal.

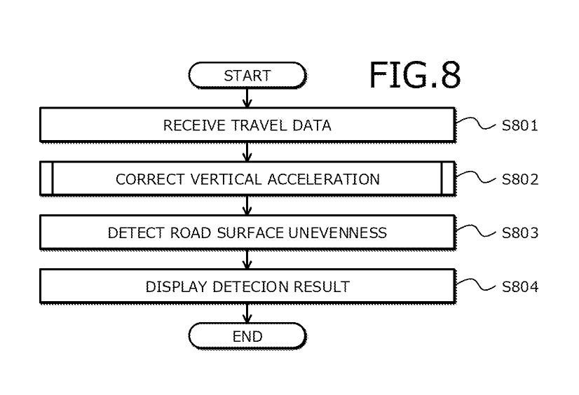

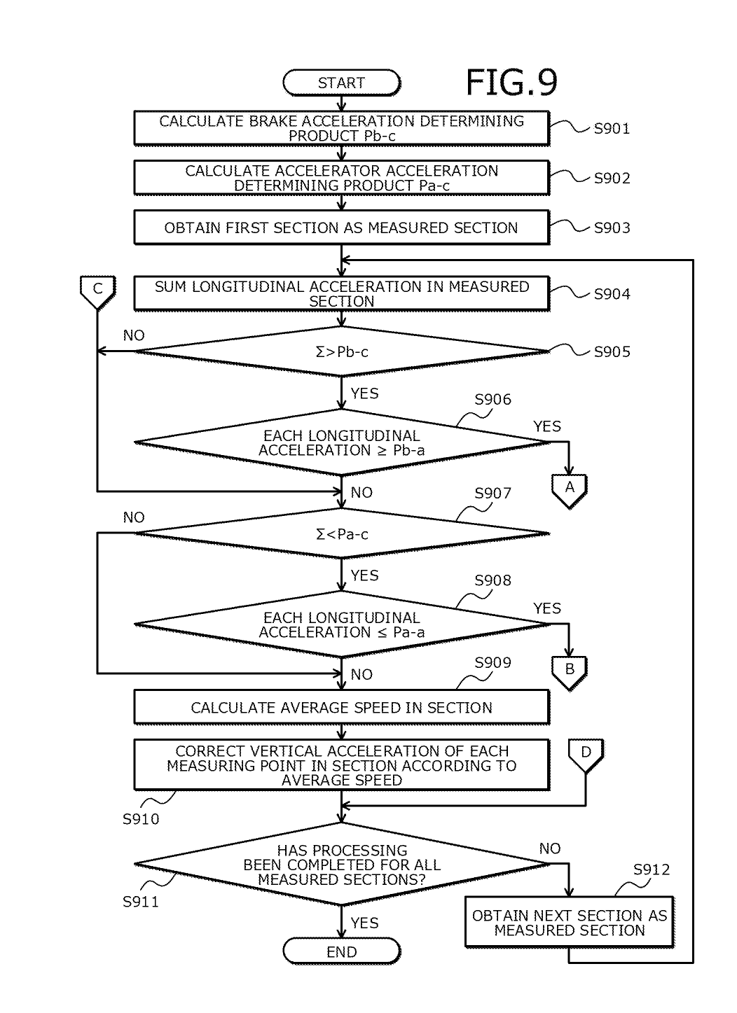

FIG. 8 is a flowchart of an example of a procedure of the road surface unevenness analysis process by the unevenness analyzer 201. In the flowchart depicted in FIG. 8, the receiving unit 701 receives the travel data 500 from the travel data measuring device 202 (step S801). The identifying unit 702 corrects the vertical acceleration included in the received travel data 500 (step S802). Correction of the vertical acceleration is explained in detail with reference to FIGS. 9, 10, and 11.

The executing unit 703 compares the corrected vertical acceleration and the road surface unevenness detection threshold, and detects road surface unevenness (step S803). The executing unit 703 determines that road surface unevenness is present at a point indicated by the longitude and latitude, when the corrected vertical acceleration is greater than the road surface unevenness detection threshold. The display unit 704 displays locations of detected road surface unevenness (step S804), ending the series of operations according to the flowchart. By executing the flowchart, the unevenness analyzer 201 detects road surface unevenness and displays locations of detected road surface unevenness.

FIG. 9 is a flowchart of an example of a procedure of a vertical acceleration correction process by the unevenness analyzer 201. In the flowchart depicted in FIG. 9, the identifying unit 702 calculates the brake acceleration determining product Pb-c (step S901). More specifically, for example, Pb-c is calculated by equation (1) using the non-brake longitudinal acceleration Pb-a, where n is a measuring point count of measuring points in a measured section.

Pb-c=Pb-a×n (1)

The identifying unit 702 calculates the accelerator acceleration determining product Pa-c (step S902). More specifically, for example, Pa-c is calculated by equation (2) using the non-accelerator longitudinal acceleration Pa-a, where n is the measuring point count of the measured section.

Pa-c=Pa-a×n (2)

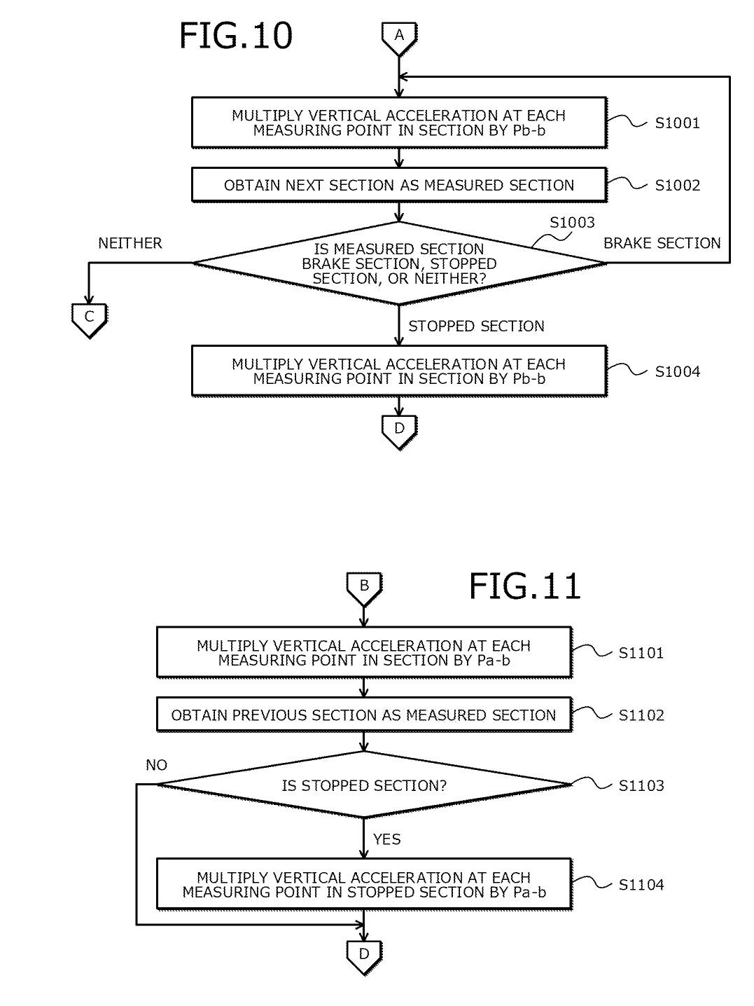

The identifying unit 702 obtains the first section as the measured section (step S903). The identifying unit 702 sums the longitudinal acceleration in the obtained measured section and sets the resulting sum as Σ (step S904). The identifying unit 702 determines whether Σ is greater than Pb-c, as a rough determination of whether the obtained measured section is a brake section (step S905). If Σ is greater than Pb-c (step S905: YES), the identifying unit 702 determines whether each longitudinal acceleration in the obtained measured section is the non-brake longitudinal acceleration Pb-a or greater, as a determination of whether the obtained measured section is a brake section (step S906). If each longitudinal acceleration in the obtained measured section is the non-brake longitudinal acceleration Pb-a or greater (step S906: YES), the obtained measured section is a brake section and therefore, the unevenness analyzer 201 transitions to operations in a flowchart that is depicted in FIG. 10 and depicts an example of a brake section identifying process. If each longitudinal acceleration in the obtained measured section is not the non-brake longitudinal acceleration Pb-a or greater (step S906: NO), the obtained measured section is not a brake section and therefore, the unevenness analyzer 201 transitions to step S907 for identification of an accelerator section.

If Σ is not greater than Pb-c (step S905: NO), the identifying unit 702 determines whether Σ is less than Pa-c, as a rough determination of whether the obtained measured section is an accelerator section (step S907). If Σ is less than Pa-c (step S907: YES), the identifying unit 702 determines whether each longitudinal acceleration in the obtained measured section is the non-accelerator longitudinal acceleration Pa-a or less, as a determination of whether the obtained measured section is an accelerator section (step S908). If each longitudinal acceleration in the obtained measured section is the non-accelerator longitudinal acceleration Pa-a or less (step S908: YES), the obtained measured section is an accelerator section and therefore, the unevenness analyzer 201 transitions to operations in a flowchart that is depicted in FIG. 11 and depicts an example of an accelerator section identifying process. If each longitudinal acceleration in the obtained measured section is not the non-accelerator longitudinal acceleration Pa-a or less (step S908: NO), the obtained measured section is not an accelerator section and therefore, the unevenness analyzer 201 transitions to step S909.

If Σ is not less than Pa-c (step S907: NO), the identifying unit 702 calculates an average speed in the obtained measured section (step S909). For example, the identifying unit 702 sums the speeds in the obtained measured section and divides by the measuring point count n of the measured section to calculate the average speed. The executing unit 703 corrects the vertical acceleration of each measuring point in the measured section according to the average speed (step S910). More specifically, for example, when the average speed in the obtained measured section is 0 to 20 km/h, the executing unit 703 multiples the vertical acceleration at each measuring point in the measured section by the 0-20 km/h_correction coefficient Ps-a and corrects the vertical acceleration; and performs similar operations in cases where the average speed in the obtained measured section is 21 to 40 km/h, 41 to 50 km/h, or 81+km/h. When the average speed in the obtained measured section is 51 to 80 km/h, the executing unit 703 does not correct the vertical acceleration.

The identifying unit 702 determines whether processing has been completed for all sections (step S911). If processing has not been completed for all sections (step S911: NO), the identifying unit 702 obtains the next section as the measured section (step S912), returns to step S904, and performs processing with respect to the obtained measured section. If processing has been completed for all sections (step S911: YES), the identifying unit 702 ends the vertical acceleration correction process, ending the series of operations in the flowchart. By executing the flowchart, the unevenness analyzer 201 identifies the measured section and when the measured section is not an accelerator section or a brake section, the unevenness analyzer 201 corrects the vertical acceleration according to the speed the vehicle 203.

FIG. 10 is a flowchart of an example of a procedure of the brake section identifying process by the unevenness analyzer 201. In the flowchart depicted in FIG. 10, since the section has been identified to be a brake section, the executing unit 703 multiplies the vertical acceleration at each measuring point in the section by the brake correction coefficient Pb-b and corrects the vertical acceleration (step S1001). The identifying unit 702 obtains the next section as the measured section (step S1002).

The identifying unit 702 identifies the measured section to be a brake section, a stopped section, or neither (step S1003). The identifying unit 702 identifies the obtained measured section to be a brake section, when each longitudinal acceleration in the obtained measured section is the non-brake longitudinal acceleration Pb-a or greater. Further, the identifying unit 702 identifies the obtained measured section to be a stopped section, when the latitude and longitude in the obtained measured section is continuously one half the measuring point count n of the obtained measured section or greater. The identifying unit 702 identifies the obtained measured section to be “neither” when the obtained measured section is identified to not be a brake section or a stopped section.

If the obtained measured section is identified to be a brake section (step S1003: brake section), the unevenness analyzer 201 returns to step S1001, and the identifying unit 702 corrects the vertical acceleration of the section. If the obtained measured section is identified to be a stopped section (step S1003: stopped section), the executing unit 703 multiplies the vertical acceleration at each measuring point in the stopped section by the brake correction coefficient Pb-b and corrects the vertical acceleration (step S1004). Thereafter, the identifying unit 702 returns to step S911 depicted in FIG. 9.

If the obtained measured section is identified to be “neither” (step S1003: neither), the identifying unit 702 returns to step S907 depicted in FIG. 9 and performs identification for an accelerator section, ending the series of operations in the flowchart. By executing the flowchart, the unevenness analyzer 201 performs identification for a brake section and a stopped section, and when the measured section is a brake section or a stopped section, the unevenness analyzer 201 corrects the vertical acceleration by the brake correction coefficient Pb-b.

FIG. 11 is a flowchart of an example of a procedure of the accelerator section identifying process by the unevenness analyzer 201. In the flowchart depicted in FIG. 11, since the section has been identified to be an accelerator section, the executing unit 703 multiplies the vertical acceleration at each measuring point in the section by the accelerator correction coefficient Pa-b and corrects the vertical acceleration (step S1101). The identifying unit 702 obtains the previous section as the measured section (step S1102).

The identifying unit 702 determines whether the obtained measured section is a stopped section (step S1103). The identifying unit 702 identifies the obtained measured section to be a stopped section when the latitude and longitude in the obtained measured section is continuously one half the measuring point count n of the obtained measured section or greater.

If the obtained measured section is identified to be a stopped section (step S1103: YES), the executing unit 703 multiplies the vertical acceleration at each measuring point in the stopped section by the accelerator correction coefficient Pa-b and corrects the vertical acceleration (step S1104). Thereafter, the identifying unit 702 returns to step S911 depicted in FIG. 9.

If the obtained measured section is identified to not be a stopped section (step S1103: NO), the identifying unit 702 returns to step S911 depicted in FIG. 9, ending the series of operations in the flowchart. By executing the flowchart, the unevenness analyzer 201 performs identification for a stopped section, and when the measured section is an accelerator section or a stopped section, the unevenness analyzer 201 corrects the vertical acceleration by the accelerator correction coefficient Pa-b.

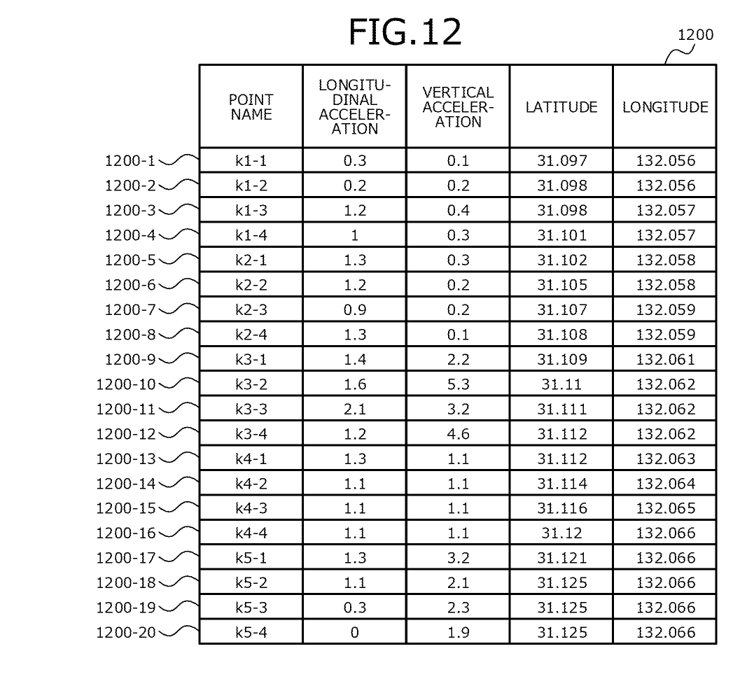

FIG. 12 is a diagram depicting an example of travel data 1200 in the brake section identifying process by the unevenness analyzer 201. One example of brake section identification by the unevenness analyzer 201 will be described using the travel data 1200. In the present example, processes related to an accelerator section will be omitted.

In the present example, the measuring point count n of the measured section is assumed to be 4 and the values indicated in FIG. 6 will be used as the analysis parameter 600. The travel data 1200 depicted in FIG. 12 is a collection of the fields for brake section identification in the travel data 500 depicted FIG. 5. In FIG. 12, the travel data 1200 has fields for point names, longitudinal acceleration, vertical acceleration, latitude, and longitude, and stores travel data information (for example, travel data information 1200-1 to 1200-20) as records consequent to information being set into the respective fields.

Here, a point name is an identifier of a measuring point. k1-1 to k1-4, k2-1 to k2-4, k3-1 to k3-4, k4-1 to k4-4, k5-1 to k5-4 respectively correspond to one measured section. The travel data 1200 includes five measured sections. The longitudinal and the vertical acceleration; and the latitude and longitude respectively correspond to the same information as the longitudinal and the vertical acceleration; and the latitude and longitude in the travel data 500 depicted in FIG. 5.

The identifying unit 702 calculates the brake acceleration determining product Pb-c for the travel data 1200 depicted in FIG. 12, where Pb-a=1.1, n=4, and therefore, calculates:

Pb-c=1.1×4=4.4

The identifying unit 702 obtains the first section k1-1 to k1-4 as measured section#1. The identifying unit 702 calculates the sum Σ of the longitudinal acceleration in measured section#1. From the travel data information 1200-1 to 1200-4 in FIG. 12, Σ is:

Σ=0.3+0.2+1.2+1.0=2.7

The identifying unit 702 compares the calculated Σ and Pb-c. Since Σ>Pb-c is not true, the identifying unit 702 identifies measured section#1 to not be a brake section.

The identifying unit 702 obtains the next section k2-1 to k2-4 as measured section#2. The identifying unit 702 calculates the sum Σ of the longitudinal acceleration in measured section#2. From the travel data information 1200-5 to 1200-8 in FIG. 12, Σ is:

Σ=1.3+1.2+0.9+1.3=4.7

The identifying unit 702 compares the calculated Σ and Pb-c. Since Σ>Pb-c is true, the identifying unit 702 determines that measured section#2 may be a brake section. The identifying unit 702 determines whether each longitudinal acceleration in measured section#2 is the non-brake longitudinal acceleration Pb-a or greater. Since the longitudinal acceleration 0.9 in travel data information 1200-7 is not the Pb-a or greater, the identifying unit 702 identifies measured section#2 to not be a brake section.

The identifying unit 702 obtains the next section k3-1 to k3-4 as measured section#3. The identifying unit 702 calculates the sum Σ of the longitudinal acceleration in measured section#3. From the travel data information 1200-9 to 1200-12 depicted in FIG. 12, Σ is:

Σ=1.4+1.6+2.1+1.2=6.3

The identifying unit 702 compares the calculated Σ and Pb-c. Since Σ>Pb-c is true, the identifying unit 702 determines that measured section#3 may be a brake section. The identifying unit 702 determines whether each longitudinal acceleration in measured section#3 is the non-brake longitudinal acceleration Pb-a or greater. Since each longitudinal acceleration in measured section#3 is Pb-a or greater, the identifying unit 702 identifies measured section#3 to be a brake section.

The executing unit 703 multiplies each vertical acceleration included in the travel data information 1200-9 to 1200-12 by the brake correction coefficient Pb-b 0.3 and respectively corrects each to 0.66, 1.59, 0.96, and 1.38.

The identifying unit 702 obtains the next section k4-1 to k4-4 as measured section#4. The identifying unit 702 determines whether measured section#4 is a stopped section. In the travel data information 1200-13 to 1200-16 depicted in FIG. 12, since the latitude and longitude included in two or more successive records are not the same, the identifying unit 702 identifies measured section#4 to not be a stopped section.

The identifying unit 702 calculates the sum Σ of the longitudinal acceleration in measured section#4. From the travel data information 1200-13 to 1200-16 depicted in FIG. 12, Σ is:

Σ=1.3+1.1+1.1+1.1=4.6

The identifying unit 702 compares the calculated Σ and Pb-c. Since Σ>Pb-c is true, the identifying unit 702 determines that measured section#4 may be a brake section. The identifying unit 702 determines whether each longitudinal acceleration in measured section#4 is the non-brake longitudinal acceleration Pb-a or greater. Since each longitudinal acceleration in measured section#4 is Pb-a or greater, the identifying unit 702 identifies measured section#4 to be a brake section.

The executing unit 703 corrects the vertical acceleration included in the travel data information 1200-13 to 1200-16 by the brake correction coefficient Pb-b 0.3 and respectively corrects each to 0.33, 0.33, 0.33, and 0.33.

The identifying unit 702 obtains the next section k5-1 to k5-4 as measured section#5. The identifying unit 702 determines whether measured section#5 is a stopped section. In the travel data information 1200-18 to 1200-20 depicted in FIG. 12, since the latitude and longitude included in two or more successive records are the same, the identifying unit 702 identifies measured section#5 to be a stopped section.

The identifying unit 702 multiplies each vertical acceleration included in the travel data information 1200-17 to 1200-20 by the brake correction coefficient Pb-b 0.3 and respectively corrects each to 0.96, 0.63, 0.69, and 0.57.

Up to this point, the unevenness analyzer 201 completes processing of one continuous brake section. The unevenness analyzer 201 compares the corrected vertical acceleration and the road surface unevenness detection threshold and thereby, executes road surface unevenness detection.

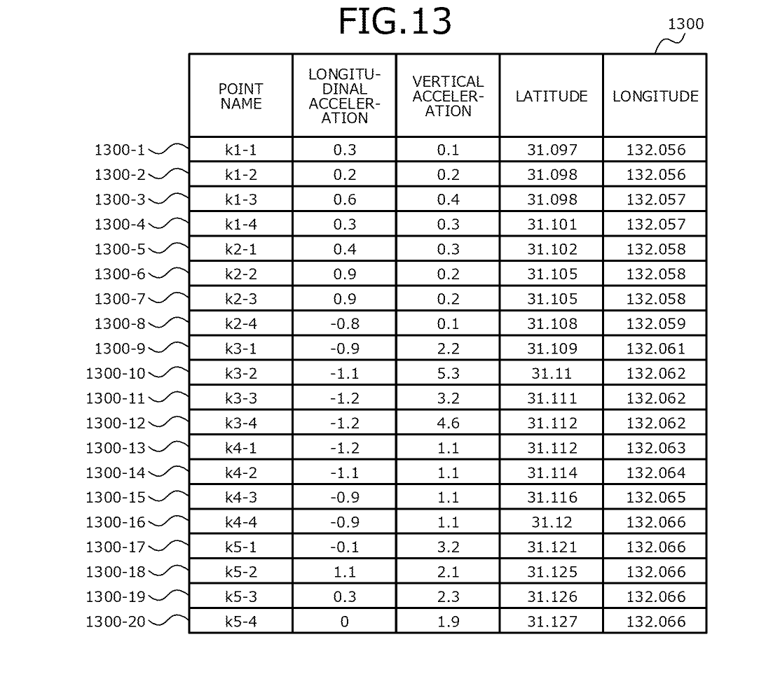

FIG. 13 is a diagram depicting an example of travel data 1300 in the accelerator section identifying process by the unevenness analyzer 201. One example of accelerator section identification by the unevenness analyzer 201 will be described using the travel data 1300. In the present example, processing related to a brake section will be omitted.

In the present example, the measuring point count n of the measured section is assumed to be 4 and the values indicated in FIG. 6 will be used as the analysis parameter 600. The travel data 1300 depicted in FIG. 13 has the same fields as the travel data 1200 depicted in FIG. 12.

The identifying unit 702 calculates the accelerator acceleration determining product Pa-c for the travel data 1300 depicted in FIG. 13, where Pa-a=−0.8, n=4, and therefore, calculates:

Pa-c=−0.8×4=−3.2

The identifying unit 702 obtains the first section k1-1 to k1-4 as measured section#1. The identifying unit 702 calculates the sum Σ of the longitudinal acceleration in measured section#1. From the travel data information 1300-1 to 1300-4 depicted in FIG. 13, Σ is:

Σ=0.3+0.2+0.6+0.3=1.4

The identifying unit 702 compares the calculated Σ and Pa-c. Since Σ<Pa-c is not true, the identifying unit 702 identifies measured section#1 to not be an accelerator section.

The identifying unit 702 obtains the next section k2-1 to k2-4 as measured section#2. The identifying unit 702 calculates the sum Σ of the longitudinal acceleration in measured section#. From the travel data information 1300-5 to 1300-8 depicted in FIG. 13, Σ is:

Σ=0.4+0.9+0.9−0.8=1.4

The identifying unit 702 compares the calculated Σ and Pa-c. Since Z<Pa-c is not true, the identifying unit 702 identifies measured section#2 to not be an accelerator section.

The identifying unit 702 obtains the next section k3-1 to k3-4 as measured section#3. The identifying unit 702 calculates the sum Σ of the longitudinal acceleration in measured section#3. From the travel data information 1300-9 to 1300-12 depicted in FIG. 13, Σ is:

Σ=−0.9−1.1−1.2−1.2=−4.4

The identifying unit 702 compares the calculated Σ and Pa-c. Since Σ<Pa-c is true, the identifying unit 702 determines that measured section#3 may be an accelerator section. The identifying unit 702 determines whether each longitudinal acceleration in measured section#3 is the non-accelerator longitudinal acceleration Pa-a or less. Since each longitudinal acceleration in measured section#3 is Pa-a or less, the identifying unit 702 identifies measured section#3 to be an accelerator section.

The executing unit 703 multiplies each vertical acceleration included in the travel data information 1300-9 to 1300-12 by the accelerator correction coefficient Pa-b 0.2 and respectively corrects each to 0.44, 1.06, 0.64, and 0.92.

The identifying unit 702 again obtains the previous section k2-1 to k2-4 as measured section#2. The identifying unit 702 determines whether measured section#2 is a stopped section. In the travel data information 1300-6 to 1300-7 depicted in FIG. 13, since the latitude and longitude in two or more successive records is the same, the identifying unit 702 identifies measured section#2 to be a stopped section.

Up to this point, the unevenness analyzer 201 completes processing of one continuous accelerator section. Subsequently, the unevenness analyzer 201 sequentially processes the measured sections from measured section#4. Since measured section#4 is identified to be an accelerator section similarly to measured section#3, the unevenness analyzer 201 corrects the vertical acceleration included in the travel data for measured section#4.

Since measured section#3 (previous section) is identified to not be a stopped section, the unevenness analyzer 20 proceeds to processing for measured section#5 (next section). Since the unevenness analyzer 201 identifies measured section#5 to not be a brake section or an accelerator section, the unevenness analyzer 201 corrects according to the speed, the vertical acceleration included in the travel data for measured section#5.

As described, the unevenness analyzer 201 according to the second embodiment identifies travel data indicating acceleration from a stopped state and travel data indicating deceleration to a stopped state. With respect to the identified travel data, the unevenness analyzer 201 sets the sensitivity of the unevenness detection for a road surface traveled by the vehicle 203 to be lower than the sensitivity for other travel data and executes road surface unevenness detection. As a result, the unevenness analyzer 201 can reduce the effects of the accelerating state and decelerating state of the vehicle 203 on the detection of road surface unevenness and perform analysis of road surface unevenness with high accuracy.

The unevenness analyzer 201 increases the measuring threshold of the accelerometer 410 and compares the increased measuring threshold and the measured value of the accelerometer 410 indicated by the identified travel data to thereby, execute road surface unevenness detection. Further, the unevenness analyzer 201 excludes the identified travel data from detection of road surface unevenness. Further, the unevenness analyzer 201 reduces the absolute value of the value measured by the accelerometer 410 indicated in the identified travel data and compares the reduced absolute value and the measuring threshold of the accelerometer 410 to thereby, execute road surface unevenness detection.

As a result, the unevenness analyzer 201 can accurately analyze road surface unevenness for identified travel data for which the value measured by the accelerometer 410 is larger than for other travel data. Further, when the measuring threshold of the accelerometer 410 is increased, in travel data other than the identified travel data, comparison is made with the measuring threshold of the accelerometer 410 before being the increase and therefore, the unevenness analyzer 201 stores the increased measuring threshold of the accelerometer 410 and the original measuring threshold of the accelerometer 410 before the increase. Thus, the volume of storage used by the unevenness analyzer 201 increases. On the other hand, when the absolute value of the measured value of the accelerometer 410 indicated by the identified travel data is reduced, the unevenness analyzer 201 does not store the original absolute value of the measured value of the accelerometer 410 before the reduction. Therefore, volume of storage used by the unevenness analyzer 201 does not change. The measuring threshold of the accelerometer 410 is a value that differs according to the measured vehicle 203 and therefore, reducing the absolute value of the measured value of the accelerometer 410 is effective when the unevenness analyzer 201 performs road surface unevenness analysis with respect to a large number of the vehicles 203.

The unevenness analyzer 201, with respect to travel data that does not belong to identified travel data, executes road surface unevenness detection by a sensitivity that corresponds to the speed of the vehicle 203 indicated by the travel data. As a result, the unevenness analyzer 201 can reduce the effects of the speed of the vehicle 203 on road surface unevenness detection and perform analysis of road surface unevenness with high accuracy.

The unevenness analyzer 201 corrects the measuring threshold of the accelerometer 410 according to the speed of the vehicle and compares the corrected measuring threshold and the measured value of the accelerometer 410 indicated by the travel data that does not belong the identified travel data and thereby, executes road surface unevenness detection. Further, the unevenness analyzer 201 corrects according to the speed of the vehicle, the measured value of the accelerometer 410 indicated by the travel data that does not belong the identified travel data and compares the corrected measured value and the measuring threshold of the accelerometer 410 and thereby, executes road surface unevenness detection.

As a result, the unevenness analyzer 201 can accurately analyze road surface unevenness for travel data measured at different speeds. Further, when the measured value of the accelerometer 410 indicated by the travel data that does not belong the identified travel data is corrected according to the speed of the vehicle, the volume of storage used by the unevenness analyzer 201 does not change.

The unevenness analyzer 201 determines whether the vehicle 203 is in an accelerating state, based on a temporal change in the longitudinal acceleration of the vehicle 203 indicated by a first travel data group of the vehicle 203. When determining that the vehicle 203 is in an accelerating state, the unevenness analyzer 201 determines whether the vehicle 203 is in a stopped state, based on a temporal change in the position of the vehicle 203 indicated in a second travel data group of the vehicle 203, measured before the first travel data group. When determining that the vehicle is in a stopped state, the unevenness analyzer 201 identifies the first travel data group and the second travel data group as travel data indicating acceleration from a stopped state.

The unevenness analyzer 201 determines whether the vehicle 203 is in a decelerating state, based on a temporal change in the longitudinal acceleration of the vehicle 203 indicated by the first travel data group of the vehicle 203. When determining that the vehicle 203 is in a decelerating state, the unevenness analyzer 201 determines whether the vehicle 203 is in a stopped state, based on a temporal change in the position of the vehicle 203 indicted by a second travel data group of the vehicle 203, measured after the first travel data group. When determining that the vehicle 203 is in a stopped state, the unevenness analyzer 201 identifies the first travel data group and the second travel data group as travel data indicating deceleration to a stopped state.

As a result, the unevenness analyzer 201 can identify travel data the indicates acceleration from a stopped state and travel data that indicates deceleration to a stopped state, in such travel data the measured value of the accelerometer 410 is larger than for other travel data.

The unevenness analyzer 201 determines whether the total acceleration of the vehicle 203 indicated by the first travel data group of the vehicle 203 is less than the product of the first threshold and the travel data count of the first travel data group. The unevenness analyzer 201 determines that the vehicle 203 is in an accelerating state when the above total is less than the above product, and acceleration of the vehicle 203 indicated by the first travel data group of the vehicle 203 is the first threshold or less.

Further, the unevenness analyzer 201 determines whether the total acceleration of the vehicle 203 indicated by the first travel data group of the vehicle 203 is greater than the product of the second threshold and the travel data count of the first travel data group. The unevenness analyzer 201, determines that vehicle is in a decelerating state when the above total is greater than the above product, and the acceleration of the vehicle 203 indicated by the first travel data group of the vehicle 203 is the second threshold or greater.

As a result, when determining that the vehicle 203 is not in an accelerating state by comparison of the total acceleration, the unevenness analyzer 201 need not perform comparison of the acceleration of the first travel data group and therefore, can quickly determine that the vehicle 203 is not in an accelerating state. Similarly, the unevenness analyzer 201 can quickly determine that the vehicle 203 is not in a decelerating state. Since the time that the vehicle 203 travels at a constant speed is greater than the time when the vehicle 203 is in an accelerating state or decelerating state, instances when the vehicle 203 is not in an accelerating state and instances when the vehicle 203 is not in a decelerating state are frequent. By quickly determining instances when the vehicle 203 is not in an accelerating state and instances when the vehicle 203 is not in a decelerating state, the unevenness analyzer 201 can quickly execute road surface unevenness detection.

The unevenness analysis program for road surfaces described in the present embodiments can be implemented by executing a prepared program on a computer such as personal computer or work station. The unevenness analysis program for road surfaces is recorded on a computer-readable recording medium such as a hard disk, a flexible disk, CD-ROM, MO, DVD and the like, and is executed by being read from the recording medium by a computer. Further, the unevenness analysis program for road surfaces may be distributed via a network such as the Internet.

According to one aspect of the invention, an effect is achieved in that the detection accuracy of road surface unevenness can be improved.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory, computer-readable recording medium storing therein an unevenness analysis program that causes a computer to perform based on an analysis parameter, analysis of motion data of a mobile object and analysis of unevenness of a road surface traveled by the mobile object, the unevenness analysis program causing the computer to execute a process comprising:
identifying by the computer and based on a motion status of the mobile object indicated by the motion data, first motion data that is one of motion data for a predetermined period from a stopped state of the mobile object and motion data for a predetermined distance from the stopped state of the mobile object; and
performing by the computer even when the motion data of the mobile object indicates movement at a same speed, and with respect to second motion data that belongs to the identified first data, comparison with third motion data that does not belong to the identified first motion data, and executing detection of unevenness of the road surface by a reduced sensitivity.

2. The non-transitory, computer-readable recording medium according to claim 1, wherein
the executing includes one of:
executing the detection of unevenness of the road surface by increasing a measuring threshold of an accelerometer, and comparing the increased measuring threshold and a measured value of the accelerometer indicated by the identified first motion data,
excluding from the detection of unevenness in the road surface, and
executing the detection of unevenness of the road surface by reducing an absolute value of the measured value of the accelerometer indicated by the identified first motion data, and comparing the reduced absolute value of the measured value and the measuring threshold of the accelerometer.

3. The non-transitory, computer-readable recording medium according to claim 1, the process further comprising
executing by the computer and with respect to fourth motion data that does not belong to the identified first motion data, the detection of unevenness of the road surface by a sensitivity that corresponds to a speed of the mobile object indicated by the fourth motion data.

4. The non-transitory, computer-readable recording medium according to claim 3, wherein
the executing of the detection of unevenness of the road surface by a sensitivity that corresponds to the speed of the mobile object includes one of:
correcting a measuring threshold of an accelerometer according to the speed of the mobile object, and comparing the corrected measuring threshold and a measured value of the accelerometer indicated by the third motion data that does not belong to the identified first motion data, and
correcting according to the speed of the mobile object, the measured value of the accelerometer indicated by third motion data that does not belong to the identified first motion data, and comparing the corrected measured value and the measuring threshold of the accelerometer.

5. The non-transitory, computer-readable recording medium according to claim 1, the process further comprising
determining by the computer whether the mobile object is in an accelerating state, based on a temporal change in longitudinal acceleration of the mobile object indicated by a first motion data group of the mobile object; and
determining by the computer when determining that the mobile object is in the accelerating state, whether the mobile object is in a stopped state, based on a temporal change in position of the mobile object indicated by a second motion data group of the mobile object, measured before the first motion data group, wherein
the identifying includes identifying the first motion data group and the second motion data group as the first motion data that is one of motion data for a predetermined period and motion data for a predetermined distance from the stopped state of the mobile object, when the mobile object is determined to be in the stopped state.

6. The non-transitory, computer-readable recording medium according to claim 1, the process further comprising:
determining by the computer whether the mobile object is in a decelerating state, based on a temporal change in longitudinal acceleration of the mobile object indicated by a first motion data group of the mobile object; and
determining by the computer when determining that the mobile object is in the decelerating state, whether the mobile object is in a stopped state, based on a temporal change in position of the mobile object indicated by a second motion data group of the mobile object, measured after the first motion data group, wherein
the identifying includes identifying the first motion data group and the second motion data group as the first motion data that is one of motion data for a predetermined period and motion data for a predetermined distance from the stopped state of the mobile object, when the mobile object is determined to be in the stopped state.

7. The non-transitory, computer-readable recording medium according to claim 5, wherein
the determining whether the mobile object is in the stopped state includes determining that the mobile object is in the stopped state, when the second motion data group of the mobile object indicates no change in the position of the mobile object, and
the determining whether the mobile object is in the accelerating state includes determining that the mobile object is in the accelerating state, when acceleration of the mobile object indicated by the first motion data group of the mobile object is at most a first threshold.

8. The non-transitory, computer-readable recording medium according to claim 6, wherein
the determining whether the mobile object is in the stopped state includes determining that the mobile object is in the stopped state, when the second motion data group of the mobile object indicates no change in the position of the mobile object, and
the determining whether the mobile object is in the decelerating state includes determining that the mobile object is in the decelerating state, when acceleration of the mobile object indicated by the first motion data group of the mobile object is at least a second threshold.

9. The non-transitory, computer-readable recording medium according to claim 1, the process further comprising
executing by the computer, the detection of unevenness of the road surface with respect to the third motion data that does not belong to the identified first motion data, by one of:
reducing a measuring threshold of an accelerometer when a speed of the mobile object indicated by the third motion data is at most a first speed, and comparing the reduced measuring threshold and a measured value of the accelerometer indicated by the third motion data that does not belong to the identified first motion data, and
increasing an absolute value of a measured value of the accelerometer indicated by the third motion data that does not belong to the identified first motion data, and comparing the increased absolute value of the measured value and the measuring threshold of the accelerometer.

10. The non-transitory, computer-readable recording medium according to claim 1, the process further comprising
executing by the computer, the detection of unevenness of the road surface with respect to the third motion data that does not belong to the identified first motion data, by one of:
increasing a measuring threshold of an accelerometer when a speed of the mobile object indicated by the third motion data is at least a second speed, and comparing the increased measuring threshold and a measured value of the accelerometer indicated by the third motion data that does not belong to the identified first motion data, and
decreasing an absolute value of measured value of the accelerometer indicated by the third motion data that does not belong to the identified first motion data, and comparing the reduced absolute value of the measured value and the measuring threshold of the accelerometer.

11. The non-transitory, computer-readable recording medium according to claim 9, further comprising:
determining, by the computer, that the mobile object is in the accelerating state, when a sum of acceleration of the mobile object indicated by the first motion data group of the mobile object is less than a product of a first threshold and a count of motion data in the first motion data group of the mobile object, and the acceleration of the mobile object indicated by the first motion data group of the mobile object is at most a first threshold.

12. The non-transitory, computer-readable recording medium according to claim 10, further comprising:
determining, by the computer, that the mobile object is in the decelerating state, when a sum of acceleration of the mobile object indicated by the first mobile data group of the mobile object is greater than a product of a second threshold and a count of motion data in the first motion data group of the mobile object, and the acceleration of the mobile object indicated by the first mobile data group of the mobile object is at least a second threshold.

13. An unevenness analysis method of performing based on an analysis parameter, analysis of motion data of a mobile object and analysis of unevenness of a road surface traveled by the mobile object, the unevenness analysis method comprising:
identifying by a computer and based on a motion status of the mobile object indicated by the motion data, first motion data that is one of motion data for a predetermined period from a stopped state of the mobile object and motion data for a predetermined distance from the stopped state of the mobile object; and
performing by the computer even when the motion data of the mobile object indicates movement at a same speed, and with respect to second motion data that belongs to the identified first data, comparison with third motion data that does not belong to the identified first motion data, and executing detection of unevenness of the road surface by a reduced sensitivity.

14. An unevenness analyzer that performs based on an analysis parameter, analysis of motion data of a mobile object and analysis of unevenness of a road surface traveled by the mobile object, the unevenness analyzer comprising:
a storage device storing therein the motion data of the mobile object motion data; and
a control circuit configured to identify based on a motion status of the mobile object indicated by the motion data, first motion data that is one of motion data for a predetermined period from a stopped state of the mobile object and motion data for a predetermined distance from the stopped state of the mobile object; and perform even when the motion data of the mobile object indicates movement at a same speed and with respect to second motion data that belongs to the identified first data, comparison with third motion data that does not belong to the identified first motion data, and execute detection of unevenness of the road surface by a reduced sensitivity.
